(19) United States
(12) Patent Application Publication
(10) Pub. No.: US 2005/0179579 A1
(43) Pub. Date: Aug. 18, 2005

(54) Radar receiver motion compensation system and method

(76) Inventors: Shane D. Pinder, Waterloo (CA); Rick McKerracher, Waterloo (CA); Stuart Doherty, Brookville (CA)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/018,854

(22) Filed: Dec. 20, 2004

Related U.S. Application Data
(60) Provisional application No. 60/532,626, filed on Dec. 29, 2003.

(51) Int. Cl. G01S 13/90

(52) U.S. Cl. 342/25 R; 342/195; 342/161

(57) ABSTRACT

A motion compensation unit and method for use in a radar system. The motion compensation unit comprises a match filter module for producing filtered range-pulse-sensor data; a motion information module for providing motion information related to motion of the radar system; a motion compensation beamformer module connected to the match filter module and the motion information module for utilizing the motion information to provide motion-compensated range-pulse-azimuth data; and, a Doppler processing module connected to the motion compensation beamformer module to provide motion-compensated range-Doppler-azimuth data.

### CROSS REFERENCE TO RELATED APPLICATIONS

Priority Claim

This application claims priority to the following U.S. Provisional Patent Application: “Radar Receiver Motion Compensation System and Method” (Application Ser. No. 60/532,626, filed Dec. 29, 2003, attorney docket no. 12379-16).

### STATEMENT REGARDING FEDERALLY SPONSORED RESEARCH

Not Applicable

### FIELD OF THE INVENTION

The invention relates to a motion compensation system and method for use in technology that is based on the reflection of sound, light or radio waves. More particularly, this invention relates to a motion compensation system and method for use with radar systems mounted on a platform that is subject to significant platform dynamics, such as can occur when the radar is mounted to a conveyance.

### BACKGROUND OF THE INVENTION

A phased-array radar includes a directional transmitting antenna and an omni-directional receiving antenna array that are both directed to a desired surveillance area, as well as the hardware and software needed for system operation. The transmitting antenna generates a train of electromagnetic (EM) pulses that illuminate the desired surveillance area. The receiving antenna array should preferably have high and equal gain over the entire surveillance area. Objects in the surveillance area then reflect the EM pulses towards the receiving antenna array, which collects radar data. Some of the objects may be elements that must be detected (the radar signatures from these elements are referred to as “targets”) while the rest of the objects are elements that do not have to be detected (the radar signatures from these elements are referred to as “clutter” which is one type of noise in a radar system). More sophisticated pulse-coded or frequency-coded EM pulses may be used to combat range-wrap, which occurs when a reflected EM pulse (in response to a previously transmitted EM pulse) is received by the receiving antenna array after subsequent EM pulses have been transmitted.

Conventionally, the collected radar data from each antenna element, or sensor, in the receiving antenna array is then preprocessed by passing the data through a bandpass filter to filter extraneous unwanted signals in the radar data, and then through a heterodyne receiver which demodulates the radar data from the RF band to an IF band (i.e. to provide IF radar data) where analog to digital conversion occurs. The radar data collected by the receiving antenna array is complex (i.e. has real and imaginary components). Accordingly, each of the signal processing components required to perform the above-mentioned operations is implemented to handle complex data.

The IF radar data is processed by a matched filter which has a transfer function or impulse response that is related to the transmitted EM pulse. The matched filtered radar data is then separated into segments for analysis. Each segment is known in the art as a coherent integration time (CIT) or a dwell. The matched filtered radar data in each CIT is range-aligned by noting the time at which each data point was sampled relative to the time that a preceding EM pulse was transmitted. The range-aligned data may then be subjected to a combination of low-pass filtering for noise reduction and downsampling for more efficient signal processing. The output of this processing is a plurality of time series of range data where each time series is collected for a given range value. Beamforming and Doppler processing is then applied to provide processed radar, data.

A target is detected from range, Doppler and azimuth information that is generated from the processed radar data. The range information is used to provide an estimate of the target's distance from the receiving antenna array. The azimuth information provides an estimate of the angle of the target's location with respect to the center of the receiving antenna array, and the Doppler information provides an estimate of the target's radial velocity by measuring the target's Doppler shift. The target's Doppler shift is related to the change in frequency content of the EM pulse that is reflected by the target with respect to the original frequency content of that EM pulse.

As mentioned previously, range data is generated by noting the time at which data is sampled relative to the time at which a preceding EM pulse is transmitted. Doppler processing corresponds to the detection of a sinusoidal signal of frequency Δf at the pulse repetition period (i.e. the time between consecutive transmitted pulses in the coherent pulse train). Accordingly, Doppler information is generated for a given range value by subjecting the time series obtained for that range value to filter bank processing or FFT processing. The azimuth data is conventionally obtained by digital beamforming. More specifically, the radar data at a given range cell and a given Doppler cell is weighted by a complex exponential for each antenna element of the receiving antenna array and then summed across all antenna elements. The phase of the complex exponential is related to the azimuth angle, the antenna element spacing and the wavelength of the transmitted EM pulses as is well known to those skilled in the art. Beamforming gives the appearance that the receiving antenna array is tuned to a certain region of the surveillance area defined by the azimuth value in the complex exponential weights. In this fashion, many beams may be formed to simultaneously cover the entire surveillance area.

To determine a target's range, azimuth and velocity, a detector processes the generated range, azimuth and Doppler information for a given CIT. In general, the detector looks for peaks at a given cell (i.e. a data value or pixel) in a two-dimensional plot known as a range-Doppler plot. Target detection usually comprises comparing the amplitude in a given cell with the average amplitude in neighboring cells. However, the detection process is hindered by the addition of noise, which includes the clutter previously mentioned, in each cell, which may result in the missed detection of a target or the false detection of noise as a target. The noise is problematic since there will be a varying noise level in different cells as well as for radar data collected in different CITs, in different environmental conditions and at different locations.

Phased-array Radio Frequency (RF) receivers that require dynamically significant Coherent Integration Times (CITs) to discriminate intended signals from RF noise or RF clutter must either be stationary, as is usually the case, or must employ some form of compensation for any antenna array motion when mounted on platforms that can move. In current practice, standard beamforming (BF) techniques generate Direction of Arrival (DOA) observations while simultaneously applying coherent integration. However, these standard BF techniques rely on the assumption that the motion of the platform throughout a CIT is negligible. Consequently, if the motion of the platform throughout a CIT is not negligible, then a standard BF approach will provide erroneous results.

### SUMMARY OF THE INVENTION

The inventors have developed a novel BF approach to address the situation in which radar targets together with RF noise or RF clutter is received by a phased-array RF receiver that is not stationary during a coherent integration interval. In one application, the non-stationarity is due to the motion of the platform upon which the phased-array radar receiver is mounted. The inventors have found that motion compensation is preferably applied at a point in the signal processing chain where the DOA of the received RF signal is known. The result is to apply a non-standard BF technique in which motion information (i.e. positional and velocity data) is collected throughout the CIT and used to compensate for any motion of the platform. In one instance, the motion information is provided by an Inertial Navigation System (INS).

In one aspect, the present invention provides a motion compensation unit for use in a radar system. The motion compensation unit comprises a match filter module for producing filtered range-pulse-sensor data; a motion information module for providing motion information related to motion of the radar system; a motion compensation beamformer module connected to the match filter module and the motion information module for utilizing the motion information to provide motion-compensated range-pulse-azimuth data; and, a Doppler processing module connected to the motion compensation beamformer module to provide motion-compensated range-Doppler-azimuth data.

In another aspect, the present invention provides a method of motion compensation for a radar system. The method comprises match filtering radar data for producing filtered range-pulse-sensor data; obtaining motion information related to motion of the radar system; beamforming the filtered range-pulse-sensor data according to the motion information to provide motion compensated range-pulse-azimuth data; and, Doppler processing the motion compensated range-pulse-azimuth data to provide motion-compensated range-Doppler-azimuth data.

In a further aspect, the invention provides systems and methods for determining phase corrections for motion compensation processing. The systems and methods can be used advantageously for radar systems, such as High Frequency Surface Wave Radar (HFSWR) radar systems. HFSWR systems use dynamically significant Coherent Integration Times (CITs) to discriminate intended signals from RF noise or RF clutter. For such dynamically significant CITs, some form of compensation for antenna array motion should be employed. In at least some embodiments of the invention, motion compensation is applied at a point in the signal processing chain where the Direction Of Arrival (DOA) of the radio frequency (RF) signal is known.

Advantageously, at least some embodiments of this aspect of the invention can be applied to situations where a radar is mounted to a platform on a conveyance (e.g., a ship, barge, tank, plane, truck, etc.) capable of movement in any one or more directions during the time radar is operating. Standard Beam Forming (BF) techniques using the Fast Fourier Transform (FFT) generate DOA observations while simultaneously applying coherent integration, but these FFT BF techniques rely on the assumption that the motion of the platform throughout a CIT is negligible. If the motion of the platform throughout a CIT is not negligible (e.g., as with a moving ship or barge), a motion compensated BF approach is required, such as provided herein.

In one embodiment, the invention provides a method of motion compensation for a radar system, wherein the radar system comprises an antenna having at least one antenna element with a phase center, wherein the method comprises:
match filtering radar data for producing filtered range-pulse-sensor data;
obtaining motion information related to motion of the radar system;
obtaining, for a desired coherent integration time (CIT) of the radar system, rotation and translation information associated with movement of the radar system over the desired CIT;
determining, using at least a portion of rotation and translation information, a change in the location of the phase center of the antenna element over the CIT;
computing, based on the change in location of the phase center, a phase correction for the antenna element;
motion-compensated beamforming the filtered range-pulse-sensor data according to the motion information to provide motion compensated range-pulse-azimuth data; and
Doppler processing the motion compensated range-pulse-azimuth data to provide motion-compensated range-Doppler-azimuth data.

The phase correction can be used as part of the motion-compensated beamforming of the filtered range-pulse-sensor data. The phase correction can be applied to the motion compensated range-pulse-azimuth data, such as being applied as part of beamforming. In a further embodiment, a direction of arrival (DOA) can be acquired for radio frequency (RF) signals returning to the antenna. The change in location of the phase center can be presented by a set of directional components, wherein computing a phase offset further comprises selecting, from the set of directional components, a directional component that is substantially parallel to the DOA, and this selected directional component can be used to compute the phase correction for the antenna element.

The motion compensation method can be used with a radar systems such as a high frequency radar system, high frequency surface wave radar (HFSWR), or an over the horizon (OTH) radar, a radar system capable of operation for at least one frequency in the frequency range of 2 to 40 MHz, and a radar system operably coupled to a conveyance intended for navigation on water, such as a barge.

In a further embodiment, the invention includes a method of motion compensation for a radar system, wherein the radar system comprises an antenna having at least one antenna element with a phase center, wherein the method comprises:
match filtering radar data for producing filtered range-pulse-sensor data;
obtaining motion information related to motion of the radar system;
obtaining, for a desired coherent integration time (CIT) of the radar system, rotation and translation information associated with movement of the radar system over the desired CIT;
determining, using at least a portion of rotation and translation information, a change in the location of the phase center of the antenna element over the CIT;
computing, based on the change in location of the phase center, a phase correction for the antenna element;
motion-compensated beamforming the filtered range-pulse-sensor data according to the motion information to provide motion compensated range-pulse-azimuth data, wherein beamforming comprises:
   Doppler processing the filtered range-pulse-sensor data to provide range-Doppler-sensor data;
   beamform processing the filtered range-Doppler-sensor data to provide range-Doppler-azimuth data; and,
   inverse Doppler processing and phase demodulating the range-Doppler-azimuth data based on the motion information to provide the motion-compensated range-pulse-azimuth data; and
Doppler processing the motion compensated range-pulse-azimuth data to provide motion-compensated range-Doppler-azimuth data.

The inverse Doppler processing can, for example, comprise applying a Hilbert Transform while phase demodulating the range-Doppler-azimuth data based on the motion information to produce the motion-compensated range-pulse-azimuth data.

In another embodiment, the invention provides a method for determining motion compensation for a radar system, the radar system comprising an antenna having at least one antenna element with a phase center, the method comprising:
obtaining, for a desired coherent integration time (CIT) of the radar system, rotation and translation information associated with movement of the radar system over the desired CIT;
determining, using at least a portion of rotation and translation information, a change in the location of the phase center of the antenna element over the CIT; and
computing, based on the change in location of the phase center, a phase correction for the antenna element.

The rotation and translation information can comprise a set of motion information coordinates, the motion information coordinates associated with degrees of freedom of motion of the radar system. The set of motion information coordinates can comprise at least one of surge displacement, sway displacement, heave displacement, pitch angular displacement, yaw angular displacement, and roll angular displacement. The displacement of each of these respective coordinates can be obtained as a function of time, and the change in location of the phase center can be determined using the displacement of each motion information coordinate as a function of time.

In still another embodiment, the invention provides a motion compensation unit for use in a radar system, the radar system comprising an antenna having at least one antenna element with a phase center, the motion compensation unit comprising a match filter module, a motion information module, a motion compensation beamformer module, and a Doppler processing module. The match filter module produces filtered range-pulse-sensor data. The motion information module provides motion information related to the motion of the radar system, wherein the motion information further comprises phase correction information associated with movement of the phase center of the antenna element. The motion compensation beamformer module is operably coupled to the match filter module and to the motion information module, and the motion compensation beamformer module uses the motion information to provide motion-compensated range-pulse-azimuth data. The Doppler processing module is operably coupled to the motion compensation beamformer module, and the Doppler processing module provides motion-compensated range-Doppler-azimuth data.

In yet another embodiment, the invention provides a high frequency radar system adapted for use on a vessel, the radar system comprising an antenna, a high frequency receiver, a match filter, a motion information module, a motion compensation beamformer, and a Doppler processor. The antenna comprises at least one element, the element having a phase center. The high frequency receiver is operably coupled to the antenna. The match filter is operably coupled to the receiver, the match filter producing filtered range-pulse-sensor data. The motion information module provides motion information related to motion of the radar system, wherein the motion information comprises phase correction information associated with movement of the phase center of the antenna element. The motion compensation beamformer is operably coupled to the match filter and to the motion information module, and the motion compensation beamformer uses the motion information to provide motion-compensated range-pulse-azimuth data. The Doppler processor is operably coupled to the motion compensation beamformer, and the Doppler processor provides motion-compensated range-Doppler-azimuth data. An optional inertial navigation system can be operably coupled to the motion compensation beamformer.

In an additional embodiment, the invention provides a motion compensation system for use with a radar system, the radar system comprising an antenna having at least one antenna element with a phase center, wherein the motion compensation system comprises means for providing filtered range-pulse-sensor data, means for providing phase correction information associated with movement of the phase center of the antenna element, means for providing motion-compensated range-pulse-azimuth data based on the filtered range-pulse-sensor data and the phase correction information, and means for providing motion-compensated range-Doppler-azimuth data based on the motion-compensated range-pulse-azimuth data.

Details relating to these and other embodiments of the invention are described more fully herein.

### BRIEF DESCRIPTION OF THE DRAWINGS

For a better understanding of the present invention and to show more clearly how it may be carried into effect, reference will now be made, by way of example only, to the accompanying drawings which show an exemplary embodiment of the present invention and in which:

FIG. 1 is a block diagram of a motion compensation unit for use in a radar system that employs motion compensation in accordance with the present invention;

FIG. 2 is a diagram illustrating the organization of sampled IF radar data;

FIG. 3 is a block diagram of the motion compensation beamformer module of FIG. 1;

FIG. 4 is a block diagram of an alternative embodiment of the motion compensation beamformer module or FIG. 1;

FIG. 5 is a block diagram of a motion compensation system used to compute phase correction information, in accordance with one embodiment of the invention;

FIG. 6 is an illustration showing frames of reference used for motion compensation calculations in the motion compensation system of FIG. 5; and

FIG. 7 is a flow chart illustrating a method of determining motion compensation, in accordance with one embodiment of the invention.

In the drawings, like reference numbers indicate like elements.

### DETAILED DESCRIPTION OF THE INVENTION

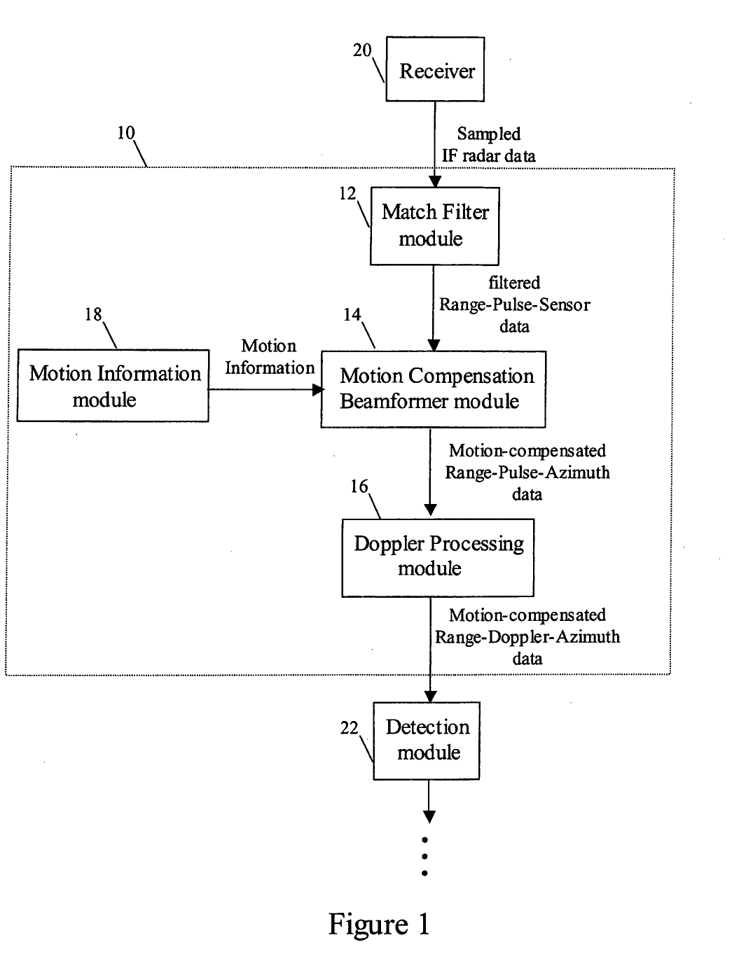

Referring now to FIG. 1, shown therein is a motion compensation unit 10 for use in a radar system that employs motion compensation in accordance with the present invention. The motion compensation unit 10 comprises a match filter module 12, a motion compensation beamformer module 14, a Doppler processing module 16, and a motion information module 18 connected as shown in FIG. 1.

The motion compensation unit 10 is connected to a receiver 20 for receiving sampled IF radar data. Accordingly, the receiver 20 is connected to a receiving array (not shown) of the radar system for receiving radar data and contains components (also not shown) for pre-processing the radar data such as filters, a heterodyne receiver, an analog-to-digital converter, a downsampler and the like as is commonly known to those skilled in the art. The receiver 20 provides sampled IF data for processing by the motion compensation unit 10.

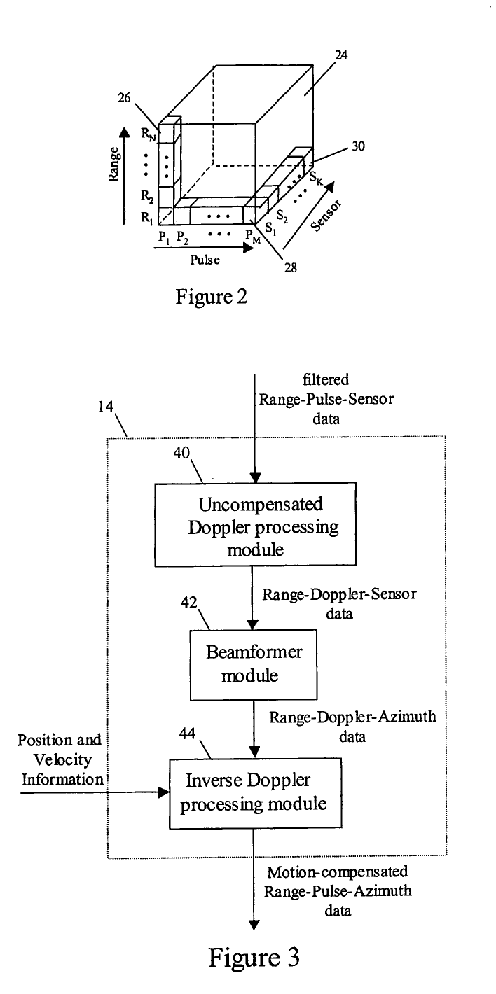

Referring now to FIG. 2, the sampled IF data can be thought of as a three-dimensional data set 24 of range-pulse-sensor data in which (arbitrarily) the range dimension extends along the z axis, the pulse dimension extends along the y axis and the sensor dimension extends along the x axis. A sensor is one element of the radar-receiving array and may be any receiving antenna element known to those skilled in the art. Furthermore, the sampled IF data 24 is segmented into time segments in accordance with a CIT. The CIT may be different given different radar modes of operation. The CIT may range from 10 to 40 seconds to 2 to 5 minutes depending on the type of targets that are to be detected.

Referring now to range vector 26, there are a series of range cells having range index values R₁, R₂, . . . , R_{N} containing the EM values that are recorded by sensor S₁ in response to the first transmitted EM pulse. The distance represented by a given range cell is calculated by recording the time at which the EM value for the range cell was sampled with respect to the time that the corresponding EM pulse was transmitted, multiplying that time by the speed of light and dividing by two. Referring to pulse vector 28, there are a series of pulse cells having pulse index values P₁, P₂, . . . , P_{M}, containing EM data that was received from reflections of pulses that were transmitted in the CIT for the radar data recorded by sensor S₁ at the range value of the range index value R₁. Referring now to sensor vector 30, there are a series of EM values that are measured by each sensor S₁, S₂, . . . , S_{K}, at the range value of range index R₁ after the transmission of the last EM pulse (in this example). Accordingly, each of the EM values contained within the sensor vector 30 was sampled at the same time (hence the same range index R₁) after the same transmitted EM pulse.

Referring once more to FIG. 1, the match filter module 12 receives the sampled IF data and processes this data to provide filtered Range-Pulse-Sensor data. The match filter module 12 is preferably a digital filter with a transfer function that is matched to the EM pulses that are transmitted by the radar system (several different EM pulses can be used as is well known to those skilled in the art). The match filter module 12 may comprise a single digital filter that operates along the range dimension for a given pulse index Pᵢ and a given sensor Sᵢ (i.e. the matched filter operates on range vectors such as range vector 26 from the sampled IF data 24). This matched filtering operation is performed for each pulse index Pᵢ and each sensor Sᵢ. The match filtering may be done in a sequential manner such that the transfer function of the matched filter is changed depending on the pulse return being processed (i.e. matched to the EM pulse that evoked the current pulse return). Alternatively, the match filter module 12 may comprise a bank of digital filters, each having a transfer function matched to one of the transmitted EM pulses. The system would then switch the incoming pulse returns to the corresponding matched filter.

The filtered Range-Pulse-Sensor data is then provided to the motion compensation beamformer module 14, which processes the data to provide motion-compensated Range-Pulse-Azimuth data. The operation of this module is discussed in greater detail below. The Doppler processing module 16 then performs Doppler processing along the pulse dimension (or pulse domain) of the motion-compensated Range-Pulse-Azimuth data to provide motion-compensated Range-Doppler-Azimuth data. Doppler processing preferably includes performing an FFT with an appropriate window function on each pulse vector to convert the time series data for each range index value Rᵢ to a frequency series. Alternatively, instead of using the FFT to implement Doppler processing, a bank of narrowband filters may be used as is commonly known to those skilled in the art.

The motion compensation unit 10 provides the motion-compensated Range-Doppler-Azimuth data to the remainder of the radar system for processing. In one instance, the motion compensation unit 10 may be connected to a detection module 22. The detection module 22 processes the motion-corrected Range-Doppler-Azimuth data to detect targets. Other components can also be provided in the radar system such as a tracking module, a display module and the like as is commonly known to those skilled in the art.

Referring now to FIG. 3, shown therein is an exemplary embodiment of the motion compensation beamformer module 14. The motion compensation beamformer module 14 comprises an uncompensated Doppler processing module 40, a beamformer module 42 and an inverse Doppler processing module 44 connected as shown in FIG. 3.

The Doppler processing module 40 receives the filtered Range-Pulse-Sensor data x_{w}(r,p,s) and processes this data to provide Range-Doppler-Sensor data x_{D1}(r,f,s) by performing a Fast Fourier Transform (FFT) according to equation 1. In equation 1, r is a range index, p is a pulse index, s is a sensor index, f is a Doppler index and Nₚ is the number of pulses in the transmit signal for a given sensor in the Range-Pulse-Sensor data.

$${x}_{D1} ( r , f , s ) = \frac{1}{\sqrt{{N}_{p}}} {\sum }_{p = 0}^{{N}_{p - 1}} {x}_{w} ( r , p , s ) {ⅇ}^{- j2π fp / {N}_{p}} \qquad ( 1 )$$

The Doppler processing module 40 may apply an appropriate window function to the filtered Range-Pulse-Sensor data x_{w}(r,p,s) prior to applying the FFT operation. Alternatively, instead of using the FFT to implement Doppler processing, a bank of narrowband filters may be used as is commonly known to those skilled in the art.

The beamformer module 42 receives the Range-Doppler-Sensor data x_{D1}(r,f,s) and executes an FFT to produce Range-Doppler-Azimuth data x_{BF1}(r,f,φ) according to equation 2. In equation 2, φ is a DOA index, and Nₛ is the number of sensors in the Uncompensated Doppler Data. The Range-Doppler-Azimuth data is uncompensated beamformed data.

$${x}_{BF1} ( r , f , φ ) = \frac{1}{\sqrt{{N}_{s}}} {\sum }_{s = 0}^{{N}_{s - 1}} {x}_{D1} ( r , f , s ) {ⅇ}^{- j2π φ s / {N}_{s}} \qquad ( 2 )$$

Alternatively, a high-resolution spectral operator, such as the MUSIC operator, can be used rather than the FFT operator. In addition, at this stage, a method to compensate for fluctuations in DOA can be applied.

The inverse Doppler processing module 44 receives the Range-Doppler-Azimuth data x_{BF1}(r,f,φ) and executes an inverse FFT followed by phase demodulation of the platform motion using a Hilbert Transform to produce motion-compensated Range-Pulse-Azimuth data x_{BF2}(r,f,φ) according to equations 3 and 4. Equation 3 shows the inverse FFT operation in which N_{f} is the number of Doppler bins in the Range-Doppler-Azimuth data and equation 4 shows the Hilbert Transform in which φ(p,φ) are phase corrections as a function of DOA. The result of platform motion is a phase/frequency modulation of the radar signal. Accordingly, in general, any phase demodulation method can be used.

$$\begin{matrix}g ( r , p , φ ) = \frac{1}{\sqrt{{N}_{f}}} {\sum }_{f = 0}^{{N}_{f - 1}} {x}_{BF1} ( r , f , φ ) {ⅇ}^{+ j2π pf / {N}_{f}} & ( 3 ) \\ {x}_{BF2} ( r , p , φ ) = [ g ( r , p , φ ) + \frac{j}{π} {\int }_{- ∞}^{∞} \frac{g ( r , x , φ ) ⅆ x}{p - x} ] {ⅇ}^{- j2πϕ ( p , φ )} & ( 4 )\end{matrix}$$

The phase corrections φ(p,φ) are derived from position and velocity information provided by the Motion Information module 18. As will be described further herein, the data from the motion information module 18 collected throughout the CIT is used to compensate for motion of a platform (or other member) onto which a radar is mounted. This compensation includes applying corrections for antenna phase center location changes, which is effectively phase demodulation of the radar data. That is, the compensation is applied based on where the phase centers would have been had the platforms not moved. These phase corrections are dependent on the DOA of the radar return and therefore, in one embodiment, applied after time domain beamforming. Any device that can provide relatively accurate position and velocity information can be used. In one instance, the Motion Information module 18 can be an Inertial Navigation System (INS) which may preferably use GPS data. More information about computing the phase corrections φ(p,φ) is described further below.

The device provides a time series of three-dimensional position data which is then converted into a time series of one-dimensional position data in each beam direction that is provided by the beamformer module 42. The conversion from position data to phase data along a given beam direction is effected by applying a scaling factor that depends on the frequency and speed of light. This allows for calculating the contribution of platform motion to range-rate in each beam direction, which is effectively a Doppler correction for each azimuth bin. In an alternative, accurate position data can be used to adjust range values, and orientation data together with angular rates can be used to execute adaptive beamforming, which allows compensation for changes in heading.

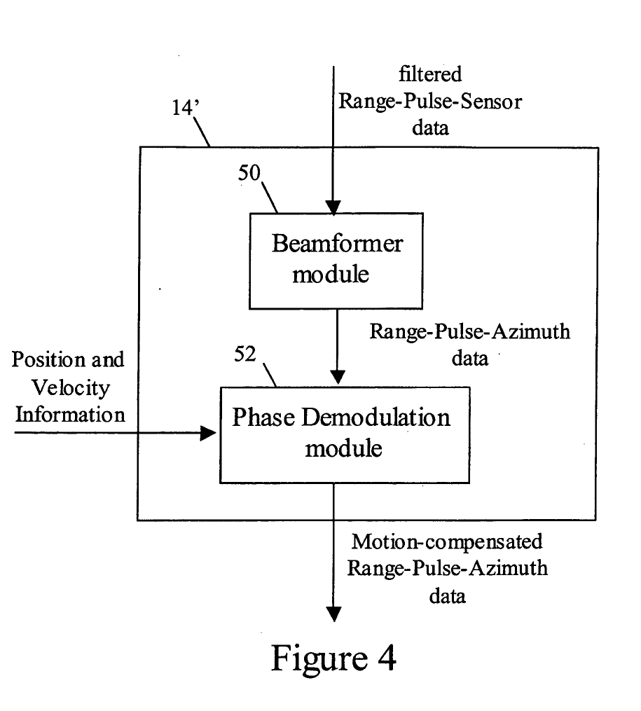

Referring now to FIG. 4, shown therein is an alternative embodiment of the motion compensation beamformer module 14′. The motion compensation beamformer module 14′comprises a beamformer module 50 and a phase demodulation module 52 connected as shown. The beamformer module 50 receives the filtered Range-Pulse-Sensor data x_{w}(r,p,s) and processes this data to provide Range-Pulse-Azimuth data x_{BF!1}(r,p,φ) by performing a Fast Fourier Transform (FFT) according to equation 5.

$${x}_{BFA1} ( r , p , φ ) = \frac{1}{\sqrt{{N}_{s}}} {\sum }_{s = 0}^{{N}_{s - 1}} {x}_{w} ( r , p , s ) {ⅇ}^{- j2πφs / {N}_{s}} \qquad ( 5 )$$

Alternatively, instead of using the FFT to implement the beamformer processing, a high-resolution spectral operator such as the MUSIC operator can be used as is commonly known to those skilled in the art.

The phase demodulation module 52 receives the Range-Pulse-Azimuth data x_{BFA1}(r,p,φ) and performs a phase demodulation operation to provide Motion-compensated Range-Pulse-Azimuth data x_{BFA2}(r,p,φ) according to equation 6. The phase demodulation module 52 applies phase demodulation according to the position and velocity information provided by the motion information module 18 as a function of DOA.
x_{BFA2}(r,p,φ)=x_{BFA1}(r,p,φ)·e^{-j2πφ(p,φ)} (6)
In equation 6, φ is a DOA (Direction Of Arrival) index and φ(pφ) are phase corrections as a function of DOA. Computation of these phase corrections is now described.

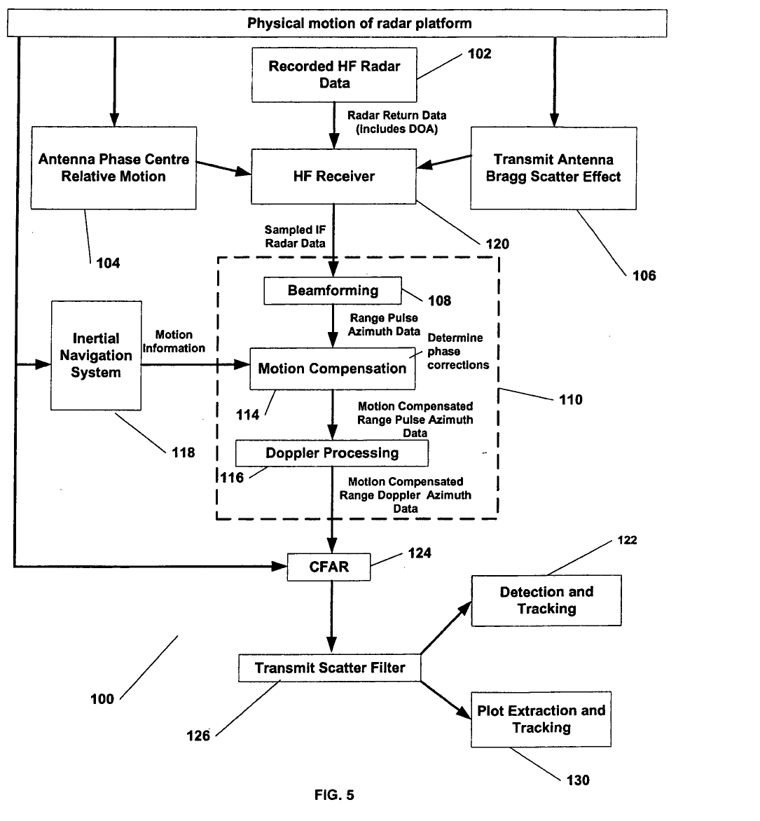

FIG. 5 is a block diagram of a motion compensation system 110 used to compute phase correction information, in accordance with one embodiment of the invention. FIG. 5 also illustrates the motion compensation system 110 in an overall radar environment 100. The system of FIG. 5 operates in substantially the same manner as the system shown in FIG. 1, and the description associated with FIG. 1 is repeated here. Referring to FIG. 5, the motion compensation system 110 includes a beamformer 108, a motion compensation processor 114, and a Doppler processor 116. The motion compensation module 110 is in communication with a radar receiver 120 (which is shown for illustrative purposes to be an HF radar receiver), an inertial navigation system 118, and a constant false alarm rate (CFAR) module 124 which can be part of the detection module 22 of FIG. 1. The CFAR module 124 can, for example, be implemented as a detection algorithm that is constructed to minimize false alarms based on statistical properties.

The radar receiver 120 receives recorded radar return data 102 captured during the operation of the radar (e.g., radar return data), which data includes raw radar data from each element in the antenna array, providing a mechanism to determine, via the signal processing techniques described herein, direction of arrival, or more accurately determine radar return signal power in each discrete direction of arrival. As noted previously, the recorded radar data 102 can be preprocessed by passing the data through a bandpass filter to filter extraneous unwanted signals in the radar data. In addition, the radar receiver 120 is affected by the physical motion of the radar platform, including the antenna phase center relative motion 104 and modulation relating to the Bragg scatter Effect on the Transmit Antenna 106 of the radar.

The radar receiver 120 is preferably a heterodyne receiver that demodulates the radar data from the RF band to an IF band, then match filterer it (as previously explained in connection with FIG. 1) before providing it to the motion compensation module 110, to result in a time series of range data. The radar receiver 120 provides sampled radar data set to the motion compensation system 110. The sampled radar data includes data relating to the physical motion of the radar platform. This sampled radar data can, for example, be affected by physical motion of the radar platform, relative motion of the antenna phase centers 104, and the effect of Bragg scattering 106. The sampled radar data can include a set of time series of the range data.

The motion compensation module 110 operates substantially the same as the motion compensation unit 10 of FIG. 1; that is, the motion compensation module 110 provides the motion-compensated Range-Doppler-Azimuth data to the remainder of the radar system (e.g., the CFAR 124) for processing. The output of the motion compensation module 110, in a first embodiment, includes data indicative of signal power as a function of range and Doppler for a desired DOA. In a second embodiment, the output of the motion compensation module 110 includes a data set representing complex signal power as a function of range across all standard beam directions.

The CFAR module 124 receives the output of the motion compensation system (e.g., motion corrected and compensated range pulse azimuth data), processes the motion-corrected and compensated Range-Doppler-Azimuth data to detect targets, and provides the motion corrected and compensated range pulse azimuth data to a transmit scatter filter 126. The transmit scatter filter 126 filters the motion corrected and compensated range pulse azimuth data to remove clutter caused by Bragg Scatter resulting from the motion of the transmit antenna.

The transmit scatter filter 126 transmits its output to a plot extraction and tracking module 130. Plot extraction and tracking is the final level of processing, where the CFAR (detector) 124 output is converted for identification of radar contacts and association of contacts from CIT to CIT. Alternately, the output of the plot extraction transmit scatter filter 126 generates a data set representing the complex signal power as a function of range and Doppler across all standard beam directions, which could then be passed on to standard algorithms for detection and tracking of radar contacts.

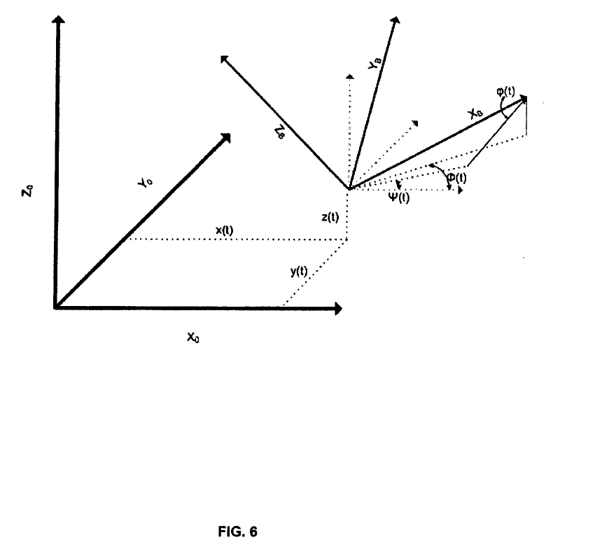

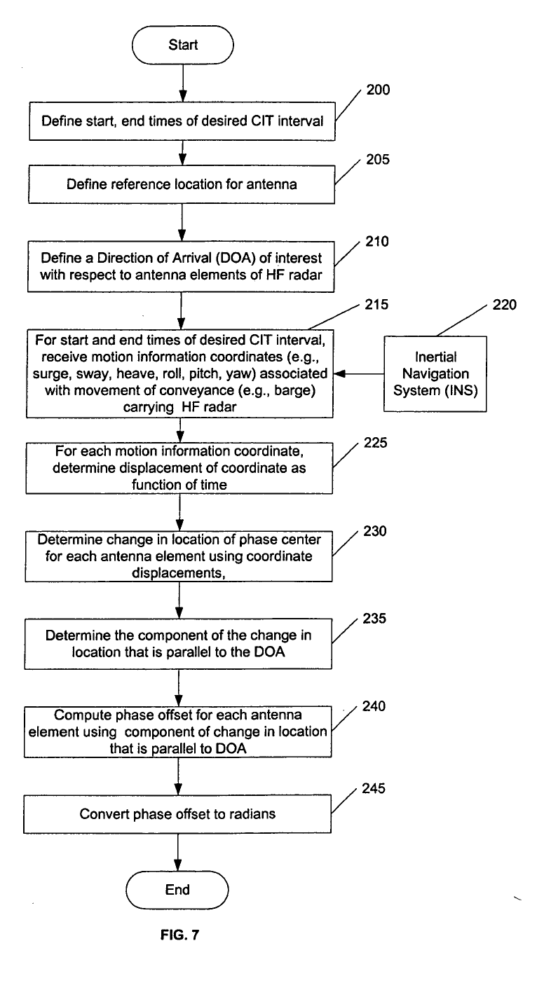

To correctly compensate for motion of the conveyance when the motion compensation module 110 performs Doppler processing and beamforming, motion information (e.g., surge, sway, heave, roll, pitch, and yaw) from the INS 118 must be taken into consideration. During the period of a CIT, the motion of the conveyance translates to motion of the antenna elements, which ultimately translates to a spatial offset of the location from which the signal being collected represents. FIG. 6 is an illustration showing frames of reference used for motion compensation calculations in the motion compensation system of FIG. 5. In particular, FIG. 6 defines the frames of reference used in phase-offset calculations. Subscript 0 in FIG. 6 refers to the frame of reference fixed to the reference point, such as the earth and established at the beginning of each CIT. Subscript B in FIG. 6 refers to the frame of reference attached to the conveyance onto which the antenna (and radar) is mounted. FIG. 7 is a flow chart illustrating a method of determining motion compensation, in accordance with one embodiment of the invention. This method is discussed further below.

Referring to FIGS. 5, 6, and 7, one underlying problem in the calculation of range offsets is finding the change in location of the phase centers for each antenna element with respect to frame ‘0’ (block 230). More specifically, to address this problem, the component of the location change that is parallel to the DOA-of-interest (block 235) is used to calculate phase offsets for each antenna element (block 240). The antenna phase centers represent fixed vectors in the ‘B’ frame, and the plane of incoming radar waves is fixed to the ‘0’ frame.

As those skilled in the art appreciate, there are various mathematical methods to determine the changes in phase center location for these three-dimensional vectors, and many different methods are usable in accordance with the invention. In one embodiment, to find the change in phase center location for each antenna from one instant to the next, with respect to the ‘0’ frame, homogenous rigid vector transformations are applied that effect both translation and rotation caused by the movements of the conveyance.

For the radar system 100, the desired CIT interval is defined (block 200). For example, HF type radar systems typically operate in the frequency range of about 2 to 40 MHz and the radar data from such HF radar systems are associated with CIT intervals (dwell times) on the order of 2-4 minutes. The reference location for the antenna of the radar system 100 is known and defined (block 205), as well. The direction at which the radar return arrives defines the direction of arrival (DOA) (block 210). For the start and end of a desired CIT interval (block 215) the INS 118 provides a set of motion information coordinates (block 220) that are associated with the motion of the conveyance. In one embodiment, this set includes the coordinates surge, sway, heave, roll, pitch, and yaw. Of course, the set of motion information coordinates can vary depending on the type of conveyance and the possible motion to which the conveyance is subjected.

Using the data from blocks 200 through 220) pᵢ^{B} is defined as the three-dimensional vector from the B-frame origin to the phase center of antenna element, i.

The order in which the yaw, pitch, and roll transformations are applied is important. The vector required for calculating the range offsets (block 230) is pᵢ⁰
pᵢ⁰(H₀^{B})=pᵢ^{B} [7]

pᵢ⁰ can be obtained by applying the transformation,

$$\begin{matrix}where \text{:} {H}_{0}^{B} = {H}_{transulation } \cdot {H}_{rotation} , & [ 8 ] \\ {H}_{transulation} = [ \begin{matrix}1 & 0 & 0 & x ( t ) \\ 0 & 1 & 0 & y ( t ) \\ 0 & 0 & 1 & z ( t ) \\ 0 & 0 & 0 & 1\end{matrix} ] , and \text{;} & [ 9 ] \\ where \text{:} {H}_{rotation} = {H}_{yaw} \cdot {H}_{pitch} \cdot {H}_{roll} , & [ 10 ] \\ {H}_{yaw } = [ \begin{matrix}cos ( ϕ ( t ) ) & - sin ( ϕ ( t ) ) & 0 & 0 \\ sin ( ϕ ( t ) ) & cos ( ϕ ( t ) ) & 0 & 0 \\ 0 & 0 & 1 & 0 \\ 0 & 0 & 0 & 1\end{matrix} ] ; & [ 11 ] \\ {H}_{pitch} = [ \begin{matrix}cos ( ψ ( t ) ) & 0 & sin ( ψ ( t ) ) & 0 \\ 0 & 1 & 0 & 0 \\ - sin ( ψ ( t ) ) & 0 & cos ( ψ ( t ) ) & 0 \\ 0 & 0 & 0 & 1\end{matrix} ] , and \text{;} & [ 12 ] \\ {H}_{roll} = [ \begin{matrix}1 & 0 & 0 & 0 \\ 0 & cos ( φ ( t ) ) & - sin ( φ ( t ) ) & 0 \\ 0 & sin ( φ ( t ) ) & cos ( φ ( t ) ) & 0 \\ 0 & 0 & 0 & 1\end{matrix} ] , & [ 13 ]\end{matrix}$$

where: x(t) is the surge displacement as a function of time;
   y(t) is the sway displacement as a function of time;
   z(t) is the heave displacement as a function of time;
   Ψ(t) is the pitch angular displacement as a function of time;
   Φ(t) is the yaw angular displacement as a function of time, and;
   φ(t) is the roll angular displacement as a function of time.

As seen above, for each motion information coordinate, the displacement of the coordinate as a function of time is determined (block 225) and used to determine the change in location of the phase center for each antenna element (block 230-see below).

Compensating the data for a single CIT requires computing a difference vector,
Δp(s, i)=pᵢ⁰(s)−pᵢ⁰(0), [14]

for each antenna element at each point in time where pᵢ⁰(0) is the location of the i-th antenna element's phase centre at the beginning of the CIT and pᵢ⁰(s) is the location of the i-th antenna element's phase center at time s. To compute pᵢ⁰(s), the rotation and translation information from the INS at time ‘s’ is used to calculate the homogeneous transformation relating the antenna element phase center with respect to the 0 frame of reference initialized at the beginning of the CIT (block 230). The difference vectors for each antenna element represent the 3-D displacement of the antenna phase center. The component of the antenna's displacement parallel to the DOA (block 235), in units of radians, is the phase correction (blocks 240 and 245),

$$ϕ ( s , φ ) = - ( Δ p ( s , i ) \cdot {φ}^{ϖ} ) \times \frac{2 π}{λ} [ rad ] , \qquad [ 15 ]$$

is the DOA represented as a 3-D vector defined with respect to the ‘0’ frame, and;

is the wavelength of the radar transmit waveform.

As an example applying the phase correction of [15], consider the following example. Referring to FIGS. 5-7, assume that the input to the motion compensation module 110 is a three-dimensional, time-domain array of complex signal power, known as Channel Data:
x_{w}(r,s,c), [16]
where: r is the range index;

s is the pulse index, and;

c is the antenna channel.

Note that the Channel Data could, for example, be the output of a match filter 12 (FIG. 1). The beamformer 108 executes a Fast Fourier Transform (FFT) to convert the Channel Data to a three-dimensional, direction-of-arrival dependent array of complex signal power, referred to as Uncompensated Beamformed Data (also referred to herein as Range-Pulse-Azimuth data)

$${x}_{BF1} ( r , s , φ ) = \frac{1}{\sqrt{{N}_{c}}} {\sum }_{c = 0}^{{N}_{c - 1}} {x}_{w} ( r , s , c ) {ⅇ}^{- j2πφ c / {N}_{c}} , \qquad [ 17 ]$$

followed by Phase Demodulation of the member/platform motion to convert the Uncompensated Beamformed Data to a three-dimensional, direction-of-arrival dependent, time-domain array of complex signal power, referred to as Compensated Beamformed Data (also referred to herein as Motion Compensated Range-Pulse Azimuth data)
x_{BF2}(r,s,φ)=x_{BF1}(r,s,φ)e^{-j2πφ(s,φ)}, [18]
where: φ is the DOA index, and;
N_{c} is the number of channels in the Channel Data.
φ(s,φ) are phase corrections as a function of direction of arrival derived from position and velocity data generated by the modeled INS.

Testing done using barge-mounted HF radars has shown that the effect of platform motion and antenna phase center relative motion can result a smearing in the Doppler characteristic of individual radar contacts once time integration is performed. This in turn results in the obliteration of weak radar contacts. A motion-compensated BF technique, as described herein, improves the detectability of these radar contacts. Future enhancements to the motion-compensated techniques described herein are contemplated. For example, in some instances, at least some of the motion-compensation techniques described herein might not be able to compensate for motion of the antenna phase centers relative to the antenna physical center, unless this effect can be accurately observed. There are methods to observe this phase center relative motion, and we expressly contemplate that the embodiments of the invention described herein can be adapted to compensate for motion of the antenna phase centers relative to the antenna physical center.

The system and method of the present invention utilizes a non-standard BF technique that can be generally applicable to technologies where an accurate observation of the RF Doppler signal is required and where dynamically significant CITs are used. The primary application of this technology, in the near term, is for the mounting of a radar system on a platform subjected to significant platform dynamics. For example, novel radar systems such as a High Frequency Surface Wave radar system mounted on platforms on a conveyance, such as an ocean-going barge, can use at least some of the methodologies described herein. In other applications, such as Global Positioning System (GPS) receiver technology, RF receivers rely on DOA observations and coherent integration to maintain phase lock on weak RF signals. GPS receivers are unable to maintain signal lock under conditions where the platform is subjected to high accelerations. A similar non-standard BF technique applied to GPS receiver technology can overcome this obstacle. The use of GPS satellites as transmitters in a bistatic radar scenario would require a similar technology, as the already weak GPS signal is further attenuated. Other potential applications include synthetic aperature radar, sonar mapping, ultrasonic imaging, and high speed photography. The motion compensation method of the present invention is also applicable in the compensation of motion related to any technology that is based on the reflection of sound, light, or radio waves.

In addition, the calculations and applications of the phase corrections φ(s,φ) described herein can be applicable to and used with virtually any radar system requiring phase correction, in addition to being usable with the systems of FIGS. 1, 3, 4, and 5 described herein.

The elements of the motion compensation unit 10 shown in FIGS. 1, 3, 4, and 5 may be implemented by any means known in the art although the use of dedicated hardware such as a digital signal processor with associated memory may be preferable. Alternatively, discrete components such as filters, comparators, multipliers, shift registers, and the like may also be used. Furthermore, certain components of the motion compensation unit 10 may be implemented by the same structure. For instance, the Doppler processing module 16, the uncompensated Doppler processing module 40 and the inverse Doppler processing module 44 may be implemented by the same hardware structure.

Alternatively, the elements of this invention may be implemented via a computer program which may be written in Matlab, C, C⁺⁺, Labview™ or any other suitable programming language embodied in a computer readable medium on a computing platform having an operating system and the associated hardware and software that is necessary to implement the motion compensation unit 10. The computer program may comprise computer instructions that are adapted to perform the steps of the motion compensation unit 10. The computer programs may comprise modules or classes, as is known in object oriented programming, that are implemented and structured according to the structure of the motion compensation unit 10. Accordingly, separate software modules may be designed for each component of the motion compensation unit 10. Alternatively, the functionality of these components may be combined into a smaller number of software modules where appropriate.

It should be understood that various modifications could be made to the preferred embodiments described and illustrated herein without departing from the present invention. For instance, instead of using the FFT operator in converting the Range-Doppler-Sensor data to Range-Doppler-Azimuth data, a high-resolution spectral estimator such as the MUSIC spectral estimator may be used. Furthermore, methods of handling secondary effects of motion can be applied at various stages within the signal processing chain of the motion compensation unit 10. For instance, compensation for any theoretical displacement of the phase center of the receiving antenna array due to platform motion can be applied between the motion information module 18 and the beamformer module 42. Other secondary effects depend wholly on the application of the RF receiver in question.

In addition to removing the unwanted signal degradation due to motion of the RF receiver, this method should also have the capability to improve the resolution of radar targets in azimuth. This is a result of the increase in synthetic aperture available from a moving radar receiver with an integrated high-accuracy positioning device.

The particular combinations of elements and features in the above-detailed embodiments are exemplary only; the interchanging and substitution of these teachings with other teachings in this and the incorporated-by-reference patents and applications are also expressly contemplated. As those skilled in the art-will recognize, variations, modifications, and other implementations of what is described herein can occur to those of ordinary skill in the art without departing from the spirit and the scope of the invention as claimed.

Further, in describing the invention and in illustrating embodiments of the invention in the figures, specific terminology, numbers, dimensions, materials, etc. are used for the sake of clarity. However the invention is not limited to the specific terms, numbers, dimensions, materials, etc. so selected, and each specific term, number, dimension, material, etc., at least includes all technical and functional equivalents that operate in a similar manner to accomplish a similar purpose. Use of a given word, phrase, number, dimension, material, language terminology, product brand, etc. is intended to include all grammatical, literal, scientific, technical, and functional equivalents. The terminology used herein is for the purpose of description and not limitation.

It should also be appreciated that the flow charts and diagrams shown herein do not depict the syntax of any particular programming language. Rather, the flow charts and/or diagram illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit and scope of the invention.

Having described the preferred embodiments of the invention, it will now become apparent to one of ordinary skill in the art that other embodiments incorporating their concepts may be used. Moreover, those of ordinary skill in the art will appreciate that the embodiments of the invention described herein can be modified to accommodate and/or comply with changes and improvements in the applicable technology and standards referred to herein. Variations, modifications, and other implementations of what is described herein can occur to those of ordinary skill in the art without departing from the spirit and the scope of the invention as claimed. It is felt therefore that these embodiments should not be limited to disclosed embodiments but rather should be limited only by the spirit and scope of the appended claims.

1. A motion compensation unit for use in a radar system, wherein the motion compensation unit comprises:
a) a match filter module producing filtered range-pulse-sensor data;
b) a motion information module providing motion information related to motion of the radar system;
c) a motion compensation beamformer module operably coupled to the match filter module and the motion information module, the motion compensation beamformer module utilizing the motion information to provide motion-compensated range-pulse-azimuth data; and,
d) a Doppler processing module operably coupled to the motion compensation beamformer module, the Doppler processing module providing motion-compensated range-Doppler-azimuth data.

2. The motion compensation unit of claim 1, wherein the motion compensation beamformer module comprises:
i) an uncompensated Doppler processing module receiving the filtered range-pulse-sensor data and providing range-Doppler-sensor data;
ii) a beamformer module operably coupled to the uncompensated Doppler processing module, the beamformer module receiving the filtered range-Doppler-sensor data and providing range-Doppler-azimuth data; and,
iii) an inverse Doppler module operably coupled to the beamformer module and the motion information module for receiving the motion information and the range-Doppler-azimuth data and providing the motion-compensated range-pulse-azimuth data.

3. The motion compensation unit of claim 2, wherein the inverse Doppler module applies a phase demodulation method based on the motion information to produce the motion-compensated range-pulse-azimuth data.

4. The motion compensation unit of claim 2, wherein the phase demodulation method uses the Hilbert transform.

5. The motion compensation unit of claim 1, wherein the motion compensation beamformer module comprises:
i) a beamformer module receiving the filtered range-pulse-sensor data and providing range-pulse-azimuth data; and,
ii) a phase demodulation module operably coupled to the beamformer module and to the motion information module, the phase demodulation module receiving the motion information and the range-pulse-azimuth data and applying a phase demodulation method to provide the motion-compensated range-pulse-azimuth data.

6. The motion compensation unit of claim 1, wherein the motion information module comprises an inertial navigational system.

7. A method of motion compensation for a radar system, wherein the method comprises:
a) match filtering radar data for producing filtered range-pulse-sensor data;
b) obtaining motion information related to motion of the radar system;
c) motion-compensated beamforming the filtered range-pulse-sensor data according to the motion information to provide motion compensated range-pulse-azimuth data; and,
d) Doppler processing the motion compensated range-pulse-azimuth data to provide motion-compensated range-Doppler-azimuth data.

8. The motion compensation method of claim 7, wherein beamforming comprises:
i) Doppler processing the filtered range-pulse-sensor data to provide range-Doppler-sensor data;
ii) beamform processing the filtered range-Doppler-sensor data to provide range-Doppler-azimuth data; and,
iii) inverse Doppler processing and phase demodulating the range-Doppler-azimuth data based on the motion information to provide the motion-compensated range-pulse-azimuth data.

9. The motion compensation method of claim 8, wherein inverse Doppler processing comprises applying a Hilbert Transform while phase demodulating the range-Doppler-azimuth data based on the motion information to produce the motion-compensated range-pulse-azimuth data.

10. The motion compensation method of claim 7, wherein beamforming comprises:
i) Beamform processing the filtered range-pulse-sensor data to provide range-pulse-azimuth data; and, ii) Phase demodulating the range-pulse-azimuth data based on the motion information to provide the motion-compensated range-pulse-azimuth data.

11. The motion compensation method of claim 7, wherein the radar system comprises an antenna having at least one antenna element with a phase center, and further comprising:
obtaining, for a desired coherent integration time (CIT) of the radar system, rotation and translation information associated with movement of the radar system over the desired CIT;
determining, using at least a portion of rotation and translation information, a change in the location of the phase center of the antenna element over the CIT; and
computing, based on the change in location of the phase center, a phase correction for the antenna element.

12. The motion compensation method of claim 11, further comprising applying the phase correction to the motion compensated range-pulse-azimuth data.

13. The motion compensation method of claim 11, wherein the phase corrections are applied as part of beamforming.

14. The motion compensation method of claim 11 further comprising acquiring a direction of arrival (DOA) at which a radio frequency (RF) signal is returned to the antenna.

15. The motion compensation method of claim 14, wherein the change in location of the phase center is represented by a set of directional components and wherein computing a phase offset further comprises selecting, from the set of directional components, a directional component that is substantially parallel to the DOA and using at least this selected directional component to compute the phase correction for the antenna element.

16. The motion compensation method of claim 15, further comprising applying the phase correction to the motion compensated range-pulse-azimuth data.

17. The motion compensation method of claim 7, wherein the radar system comprises at least one of a high frequency radar system, a high frequency surface wave radar (HFSWR) and an over the horizon (OTH) radar.

18. The motion compensation method of claim 7, wherein the radar system is capable of operation for at least one frequency in the frequency range of 2 to 40 MHz.

19. The motion compensation method of claim 7, wherein the radar system is operably coupled to a conveyance intended for navigation on water.

20. The motion compensation method of claim 8, wherein the radar system comprises an antenna having at least one antenna element with a phase center, and further comprising:
obtaining, for a desired coherent integration time (CIT) of the radar system, rotation and translation information associated with movement of the radar system over the desired CIT;
determining, using at least a portion of rotation and translation information, a change in the location of the phase center of the antenna element over the CIT; and
computing, based on the change in location of the phase center, a phase correction for the antenna element.

21. The motion compensation method of claim 20, further comprising applying the phase corrections to the range Doppler-azimuth data of (ii).

22. The motion compensation method of claim 20 further comprising acquiring a direction of arrival (DOA) at which a radio frequency (RF) signal is returned to the antenna.

23. The motion compensation method of claim 22, wherein the change in location of the phase center is represented by a set of directional components and wherein computing a phase offset further comprises selecting, from the set of directional components, a directional component that is substantially parallel to the DOA and using at least this selected directional component to compute the phase correction for the antenna element.

24. The motion compensation method of claim 23, further comprising applying the phase correction to the motion compensated range-pulse-azimuth data.

25. The motion compensation method of claim 20, wherein the radar system comprises at least one of a high frequency radar system, a high frequency surface wave radar (HFSWR) and an over the horizon (OTH) radar.

26. The motion compensation method of claim 20, wherein the radar system is operably coupled to a conveyance intended for navigation on water.

27. A method for determining motion compensation for a radar system, the radar system comprising an antenna having at least one antenna element with a phase center, the method comprising:
obtaining, for a desired coherent integration time (CIT) of the radar system, rotation and translation information associated with movement of the radar system over the desired CIT;
determining, using at least a portion of rotation and translation information, a change in the location of the phase center of the antenna element over the CIT; and
computing, based on the change in location of the phase center, a phase correction for the antenna element.

28. The method of claim 27, wherein the rotation and translation information comprises a set of motion information coordinates, the motion information coordinates associated with degrees of freedom of motion of the radar system.

29. The method of claim 28, wherein the set of motion information coordinates comprises at least one of surge displacement, sway displacement, heave displacement, pitch angular displacement, yaw angular displacement, and roll angular displacement.

30. The method of claim 28, further comprising obtaining the displacement of each respective coordinate in the set as a function of time.

31. The method of claim 30, wherein the change in location of the phase center is determined using the displacement of each motion information coordinate as a function of time.

32. The method of claim 27 further comprising acquiring a direction of arrival (DOA) at which a radio frequency (RF) signal is returned to the antenna.

33. The method of claim 32, wherein the computed phase correction is a function of the DOA.

34. The method of claim 33, wherein the change in location of the phase center comprises a set of directional components and wherein computing a phase correction further comprises selecting from the set of directional components a directional component that is substantially parallel to the DOA and using at least this selected direction component to compute the phase correction for the antenna element.

35. The method of claim 27, wherein the radar system comprises at least one of a high frequency radar system, a high frequency surface wave radar (HFSWR) and an over the horizon (OTH) radar.

36. The method of claim 27, wherein the radar system is capable of operation for at least one frequency in the frequency range of 2 to 40 MHz.

37. The method of claim 27, wherein the radar system is operably coupled to a vessel intended for navigation on water.

38. A motion compensation unit for use in a radar system, the radar system comprising an antenna having at least one antenna element with a phase center, wherein the motion compensation unit comprises:
a match filter module producing filtered range-pulse-sensor data;
a motion information module providing motion information related to the motion of the radar system, wherein the motion information further comprises phase correction information associated with movement of the phase center of the antenna element;
a motion compensation beamformer module operably coupled to the match filter module and to the motion information module, the motion compensation beamformer module using the motion information to provide motion-compensated range-pulse-azimuth data; and
a Doppler processing module operably coupled to the motion compensation beamformer module, the Doppler processing module providing motion-compensated range-Doppler-azimuth data.

39. A high frequency radar system adapted for use on a vessel, the radar system comprising:
an antenna comprising at least one element, the element having a phase center;
a high frequency receiver operably coupled to the antenna;
a match filter operably coupled to the receiver, the match filter producing filtered range-pulse-sensor data;
a motion information module providing motion information related to motion of the radar system, wherein the motion information comprises phase correction information associated with movement of the phase center of the antenna element;
a motion compensation beamformer operably coupled to the match filter and to the motion information module, the motion compensation beamformer using the motion information to provide motion-compensated range-pulse-azimuth data; and
a Doppler processor operably coupled to the motion compensation beamformer, the Doppler processor providing motion-compensated range-Doppler-azimuth data.

40. The high frequency radar system of claim 39, further comprising an inertial navigation system operably coupled to the motion compensation beamformer.

41. A motion compensation system for use with a radar system, the radar system comprising an antenna having at least one antenna element with a phase center, wherein the motion compensation system comprises:
means for providing filtered range-pulse-sensor data;
means for providing phase correction information associated with movement of the phase center of the antenna element;
means for providing motion-compensated range-pulse-azimuth data based on the filtered range-pulse-sensor data and the phase correction information; and
means for providing motion-compensated range-Doppler-azimuth data based on the motion-compensated range-pulse-azimuth data.
